(19) United States
(12) Patent Application Publication
(10) Pub. No.: US 2026/0287451 A1
(43) Pub. Date: Sep. 24, 2026

(54) THREE-ELECTRODE SENSOR INTEGRATING POSITIONING AND PRESSURE DETECTION AND MANUFACTURING METHOD THEREFOR

(71) Applicant: CHONGQING UNIVERSITY OF POSTS AND TELECOMMUNICATIONS, Chongqing (CN)

(72) Inventors: JIUFEI LUO, Chongqing (CN); YUXIN LI, Chongqing (CN); PINGAN YANG, Chongqing (CN); SHENG LU, Chongqing (CN); HAIQING LI, Chongqing (CN); ZHIDAN LUO, Chongqing (CN); XUEJUN MA, Chongqing (CN); YUNCHUN DENG, Chongqing (CN); HONGZHENG SONG, Chongqing (CN)

(21) Appl. No.: 19/678,341

(22) Filed: May 15, 2026

Related U.S. Application Data
(63) Continuation of application No. PCT/CN2025/136003, filed on Nov. 19, 2025.

(30) Foreign Application Priority Data
Dec. 16, 2024 (CN) 202411847790.7

(51) Int. Cl. G01L 5/1623; G01L 1/14; G01L 1/16; G01L 5/167

(52) U.S. Cl. CPC G01L 5/1623; G01L 5/167; G01L 1/14; G01L 1/16

(57) ABSTRACT

A three-electrode sensor integrating positioning and pressure detection includes a resistance positioning unit, two spacers, a piezoelectric unit, and an encapsulation layer connected in sequence. The resistance positioning unit is configured to detect a position subjected to force; upper portions of the two spacers are connected to edges of the resistance positioning unit, and lower portions of the two spacers are connected to edges of the piezoelectric unit, with the resistance positioning unit and the piezoelectric unit forming a cavity structure; and the piezoelectric unit is configured to detect a magnitude of force applied. The sensor provided by the present disclosure can detect pressure position and pressure magnitude simultaneously, features simple structure, independent signals, and stable performance, and possesses great application potential in multiple frontier fields such as flexible sensing, medical devices, and robot grasping.

### CROSS-REFERENCE TO RELATED APPLICATIONS

This application is a continuation of PCT/CN2025/136003, filed on Nov. 19, 2025 and claims priority of Chinese Patent Application No. 202411847790.7, filed on Dec. 16, 2024, the entire contents of which are incorporated herein by reference.

### TECHNICAL FIELD

The present disclosure relates to the technical field of sensors, and specifically to a three-electrode sensor integrating positioning and pressure detection and a manufacturing method therefor.

### BACKGROUND

With the development of smart electronic devices, wearable devices, robotics technology, medical health monitoring, and other fields, the demand for flexible, integrated sensors is increasing day by day.

Existing sensors can effectively achieve single physical quantity detection. Resistive sensors, capacitive sensors, and piezoelectric sensors can be used for detecting pressure values; photoelectric and laser sensors, capacitive sensors, resistive sensors, and magnetic sensors can be used for detecting position information; capacitive sensors are more sensitive to environmental and temperature changes; photoelectric positioning sensors require very precise structures and offer high measurement accuracy; resistive sensors feature simple structure and high sensitivity; piezoelectric sensors exhibit excellent performance in dynamic pressure detection; and magnetic sensors are often used for non-contact measurement.

Existing composite sensing technical solutions mostly adopt technical solutions where position signals and pressure signals are mixed into one, and composite single-channel transmission of composite signals. However, such technical means have the following problems: the two signals are not completely independent, thus requiring complex algorithm models for signal decoupling, resulting in high computational costs, and coupling during multi-signal transmission causes an overall performance degradation of the sensor.

Therefore, existing composite sensors suffer from problems such as output signal coupling, high cost, complex structure, and low sensitivity.

### SUMMARY

In view of this, the present disclosure provides a three-electrode sensor integrating positioning and pressure detection and a manufacturing method therefor, to solve the above problems.

A three-electrode sensor integrating positioning and pressure detection includes a resistance positioning unit, two spacers, a piezoelectric unit, and an encapsulation layer connected in sequence; the resistance positioning unit is configured to detect a position subjected to force; upper portions of the two spacers are connected to edges of the resistance positioning unit, and lower portions of the two spacers are connected to edges of the piezoelectric unit, with the resistance positioning unit and the piezoelectric unit forming a cavity structure; and the piezoelectric unit is configured to detect a magnitude of force applied.

A manufacturing method for a three-electrode sensor integrating positioning and pressure detection, used for manufacturing the above sensor, includes the steps of S1-S6.

In S1, a film is cleaned and cut to obtain the insulating layer and the encapsulation layer.

In S2, surface stains of the insulating layer and the encapsulation layer are cleaned.

In S3, an electrically conductive mixed sensitive material is coated on the lower surface of the insulating layer to form the resistance-sensitive layer, the resistance-sensitive layer is dried, and the upper electrode is attached on the resistance-sensitive layer to obtain the resistance positioning unit.

In S4, a piezoelectric material solution is prepared and polarized to obtain a polarized solution, the polarized solution is poured into a mold, followed by drying and demolding to obtain the piezoelectric layer.

In S5, a layer of metal electrode is attached on each of two surfaces of the piezoelectric layer to obtain the piezoelectric unit.

In S6, components are assembled in an order from top to bottom according to the resistance positioning unit, two spacers, the piezoelectric unit, and the encapsulation layer, in which during assembly, the two spacers are used for fixing the resistance positioning unit and the piezoelectric unit, with the resistance positioning unit and the piezoelectric unit not contacting each other when not operating, and non-contact portions form the cavity.

Beneficial effects of the present disclosure include:

By adopting a simple three-electrode structure, the volume and manufacturing process of the sensor are fundamentally simplified, overcoming the problems of complex structure and high manufacturing cost of traditional sensors, and significantly improving the miniaturization and practicability of the sensor. Through a multi-layer stacked structural design, the two modules possess the capability of independent or cooperative work without interfering with each other, simplifying the subsequent signal processing procedure, and significantly improving the real-time response performance of the sensor. By adopting emerging highly conductive sensitive materials such as silver nanowires (AgNWs) and carbon nanotubes as main raw materials for the resistance-sensitive layer of the sensor, the flexibility requirement of the sensor is ensured, and the overall signal transmission efficiency is improved.

### BRIEF DESCRIPTION OF THE DRAWINGS

FIG. 1 shows a structural schematic diagram of a sensor in Embodiment 1 of the present disclosure.

FIG. 2 shows a structural schematic diagram of a resistance positioning unit of the present disclosure.

FIG. 3 shows a structural schematic diagram of a piezoelectric unit of the present disclosure.

FIG. 4 shows a relationship between stimulation position and resistance value of a sensor in Embodiment 2 of the present disclosure.

FIG. 5 shows a relationship between stimulation position and resistance value of a sensor in Embodiment 3 of the present disclosure.

FIG. 6 shows a relationship between force applied to a piezoelectric layer and output voltage of the sensor in Embodiment 2 of the present disclosure.

FIG. 7 shows a relationship between force applied to a piezoelectric layer and output voltage of the sensor in Embodiment 3 of the present disclosure.

Reference numerals and denotations thereof: 1—insulating layer, 2—resistance-sensitive layer, 3—first spacer, 4—middle electrode layer, 41—position where a lead wire is drawn from a middle electrode layer, 5—piezoelectric layer, 6—encapsulation layer, 7—lower electrode layer, 71—position where a lead wire is drawn from a lower electrode layer, 8—second spacer, 9—upper electrode, 91—position where a lead wire is drawn from an upper electrode, and 10—cavity.

### DETAILED DESCRIPTION

To make the objectives, technical solutions, features, and advantages of the present disclosure clearer and more understandable, further descriptions are provided below in conjunction with the accompanying drawings and embodiments.

Embodiment 1 is a preferred embodiment of a three-electrode sensor integrating positioning and pressure detection according to the present disclosure, as shown in FIG. 1.

A three-electrode sensor integrating positioning and pressure detection includes a resistance positioning unit, two spacers, a piezoelectric unit, and an encapsulation layer connected in sequence; the resistance positioning unit is configured to detect a position subjected to force; upper portions of the two spacers are connected to edges of the resistance positioning unit, and lower portions of the two spacers are connected to edges of the piezoelectric unit, with the resistance positioning unit and the piezoelectric unit forming a cavity structure; and the piezoelectric unit is configured to detect a magnitude of force applied.

Further, the resistance positioning unit includes an insulating layer, a resistance-sensitive layer, and an upper electrode; the resistance-sensitive layer is arranged on a lower surface of the insulating layer, and the upper electrode is arranged on a lower surface of the resistance-sensitive layer; the piezoelectric unit includes a middle electrode layer, a piezoelectric layer, and a lower electrode layer connected in sequence; and the upper electrode, the middle electrode layer, and the lower electrode layer are used for collecting voltage signals of the sensor.

Embodiment 2 is a preferred embodiment of a manufacturing method for a three-electrode sensor integrating positioning and pressure detection provided by the present disclosure, including the steps of S1-S6.

In S1, a film was cleaned and cut to obtain an insulating layer and an encapsulation layer.

Specifically, the film adopted is a polyethylene terephthalate (PET) film; and the PET film possesses extremely high electrical insulation, which can effectively isolate electrical signals, prevent current leakage or interference, and possess high cost-effectiveness.

Further, the cut PET film has a length of 64 mm, a width of 9 mm, and a thickness of 0.2 mm.

In S2, surface stains of the insulating layer and the encapsulation layer were cleaned.

In S3, an electrically conductive mixed sensitive material was coated on a lower surface of the insulating layer to form a resistance-sensitive layer, the resistance-sensitive layer was dried, and an upper electrode was attached on the resistance-sensitive layer to obtain a resistance positioning unit.

Specifically, the resistance positioning unit includes the insulating layer, the resistance-sensitive layer, and the upper electrode; the resistance-sensitive layer is arranged on the insulating layer, and the upper electrode is arranged on the resistance-sensitive layer; the electrically conductive mixed sensitive material is formed by mixing an electrically conductive material and a thickening agent; the electrically conductive material adopts carbon nanotube dispersion liquid (CNTs) and silver nanowires (AgNWs); and the thickening agent adopts methyl cellulose (MC); the CNTs and AgNWs possess high strength and flexibility, and the electrically conductive performance is close to a metal level. If the electrically conductive material is too little, it causes difficulty in forming a conduction path on the surface of the resistance-sensitive layer and uneven distribution, thereby leading to reduction in sensor sensitivity, linearity, service life and the like.

Furthermore, 8 ml of CNTs (13 wt %), 3 ml of AgNWs (10 mg/ml), and 0.01 g of MC were selected, mixed, and stirred for 20 minutes; the resistance-sensitive layer adopted the material, used the insulating layer 1 as a base, uniformly coated the above mixed material upward, coated once, and baked dry in a drying oven environment at 50° C.; the upper electrode 9 adopted copper foil with a thickness of 0.02 mm, a length of 1 mm, and a width of 9 mm; and the resistance-sensitive layer has an effective length of 60 mm, a width of 5 mm, a thickness of 0.2 mm, and a total resistance of 198Ω. The relationship between output resistance and pressing position is shown in FIG. 4.

In S4, a piezoelectric material solution was prepared and polarized to obtain a polarized solution, the polarized solution was poured into a mold, followed by drying and demolding to obtain a piezoelectric layer.

Further, the piezoelectric material solution was formed by mixing a polymer piezoelectric material and a solvent; in this embodiment, polyvinylidene fluoride (PVDF) was adopted as the piezoelectric material, and a mixed solution of acetone and N,N-dimethylformamide was selected as the solvent; PVDF possesses good flexibility and processability, can be prepared into piezoelectric layers of different thicknesses, and the molecular chain structure of PVDF containing fluorine atoms gives PVDF high chemical stability and fatigue resistance; when subjected to pressing or bending action, electrical signals are generated on the electrode surfaces above and below the piezoelectric material, and the magnitude of the electrical signal is proportional to the amount of deformation of the piezoelectric material.

Specifically, 1.8 g of PVDF was added to mixed solvent of 6 ml of acetone and 9 ml of N,N-dimethylformamide, and 0.3 g of polyvinylpyrrolidone (PVP, K40) was added; a thermal polarization method was adopted, magnetic stirring was performed at 70° C. for 15 minutes, after turned into a transparent gel-like state, a solution was poured into a mold and naturally evaporated to form; and the obtained piezoelectric layer had a length of 60 mm, a width of 5 mm, and a thickness of 1 mm. The relationship between output voltage of the piezoelectric layer and force applied is shown in FIG. 6.

In S5, a layer of metal electrode was attached on each of two surfaces of the piezoelectric layer to obtain a piezoelectric unit.

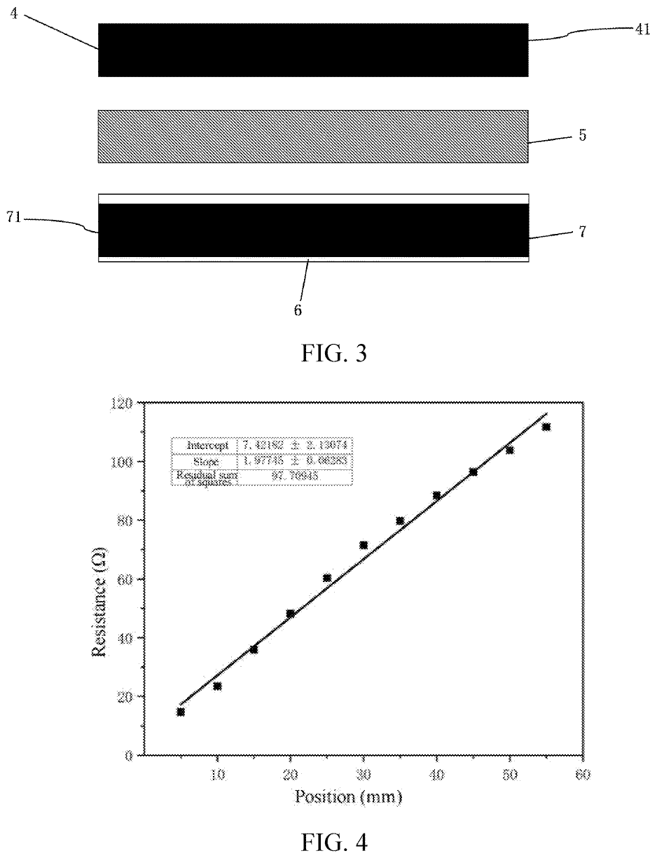

Specifically, the piezoelectric unit includes the middle electrode layer 4, the piezoelectric layer 5, and the lower electrode layer 7 connected in sequence, and the middle electrode layer 4 was connected to the resistance-sensitive layer via a cavity; both the middle electrode layer 4 and the lower electrode layer 7 adopted copper foil with a thickness of 0.02 mm, the middle electrode layer 4 was laid flat on an upper surface of the piezoelectric layer 5, the lower electrode layer 7 was pasted on an upper surface of the encapsulation layer 6, and the middle electrode layer 4 and the lower electrode layer 7 had the same width as the piezoelectric layer 5, and had a length equal to the length L of the piezoelectric layer 5 plus 2 mm to facilitate connection of lead wires. The structure of the piezoelectric unit is shown in FIG. 3.

In S6, components were assembled in an order from top to bottom according to the resistance positioning unit, the two spacers, the piezoelectric unit, and the encapsulation layer, in which during assembly, the two spacers are used for fixing the resistance positioning unit and the piezoelectric unit, with the resistance positioning unit and the piezoelectric unit not contacting each other when not operating, and non-contact portions form a cavity.

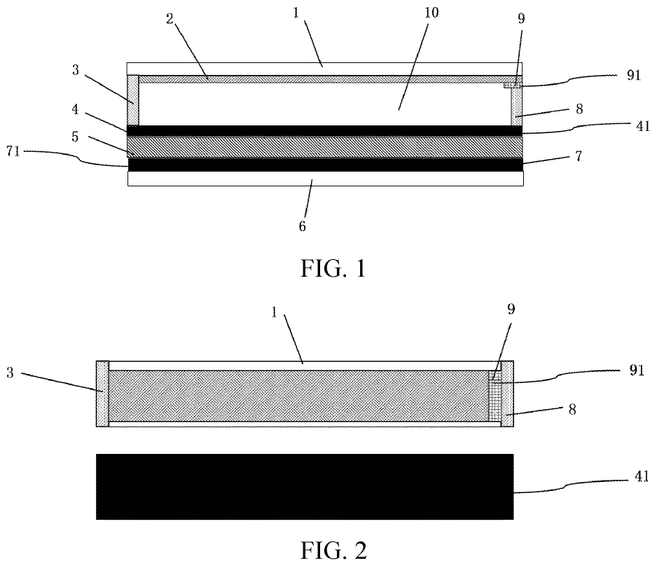

Specifically, each spacer adopted a rectangular polytetrafluoroethylene plate, the first spacer 3 had a length of 2 mm, a width of 9 mm, and a thickness of 2 mm, and the second spacer 8 had a length of 2 mm, a width of 9 mm, and a thickness of 1.78 mm, as shown in FIG. 2.

Further, in this embodiment, the sensor has an overall length of 64 mm, a width of 9 mm, and a thickness of 3.44 mm; and when the insulating layer 1 of the sensor is subjected to force and deforms, the resistance-sensitive layer 2 contacts the middle electrode layer 4, forming a conduction path among the upper electrode 9, the resistance-sensitive layer 2, and the middle electrode layer 4. A resistance value of the resistance-sensitive layer 2 is detected, and position information of the force point is determined; and the upper electrode 9 and the middle electrode layer 4 collect resistance signals, the middle electrode layer 4 and the lower electrode layer 7 collect voltage signals, the middle electrode layer 4 serves as a common working electrode for the resistance positioning unit and the piezoelectric unit, and the upper electrode 9 and the lower electrode layer 7 are respectively connected independently to the resistance positioning unit and the piezoelectric unit, thereby realizing separate detection of spatial position and pressure information of external stimuli.

Further, conductive silver adhesive was used to connect lead wires at the upper electrode 9, the middle electrode layer 4, and the lower electrode layer 7; and lead wires of the upper electrode 9 and the middle electrode layer 4 were led out from positions 91 and 41, and a lead wire of the lower electrode layer 7 was led out from position 71.

Embodiment 3 is another preferred embodiment of a manufacturing method for a three-electrode sensor integrating positioning and pressure detection.

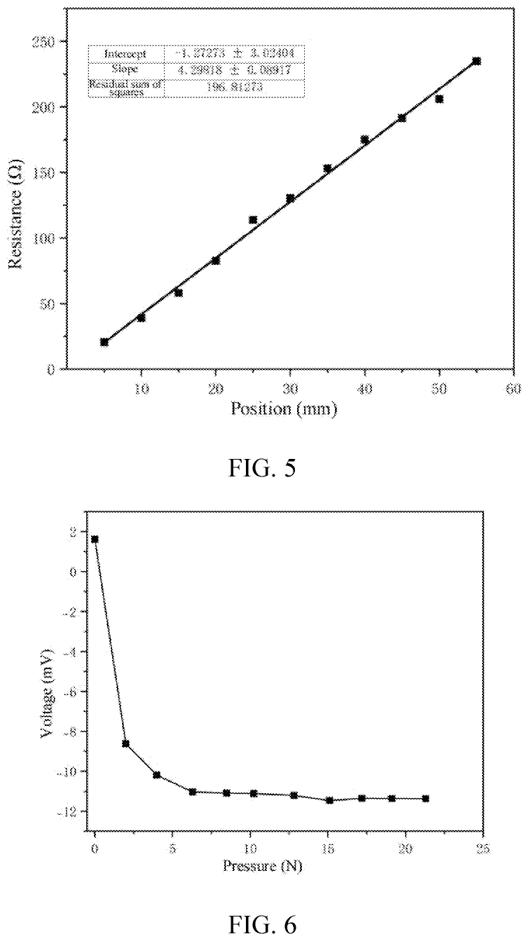

The difference between Embodiment 3 and Embodiment 2 lies in: the proportion of the conductive mixed sensitive material is different; 8 ml of CNTs (13 wt %), 1 ml of AgNWs (10 mg/ml), and 0.01 g of MC were mixed and stirred for 20 minutes, and the total resistance of the resistance-sensitive layer is 245 Q. The relationship between output resistance and pressing position is shown in FIG. 5.

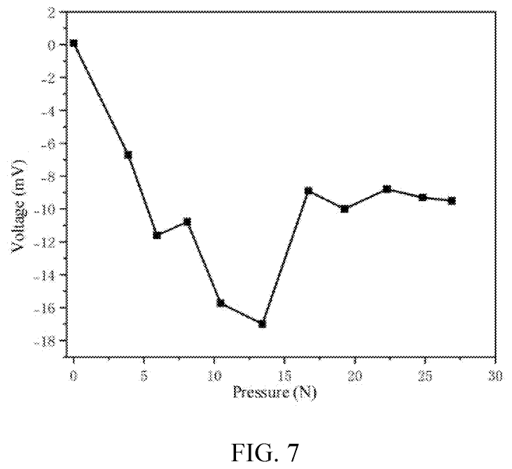

The polymer piezoelectric material selected was PVDF, and the solvent selected was a mixed solution of acetone and N,N-dimethylformamide; specifically, 1.7 g of PVDF was added to mixed solvent of 6 ml of acetone and 9 ml of N,N-dimethylformamide, 0.8 g of PVP (K40) was added, magnetic stirring was performed at 70° C. for 20 minutes, after turned into a transparent gel-like state, a solution was poured into a mold and naturally evaporated to form; and the obtained piezoelectric layer has a length of 60 mm, a width of 5 mm, and a thickness of 1 mm. The relationship between output voltage of the piezoelectric layer and force applied is shown in FIG. 7.

Finally, it is to be noted that the above descriptions are only partial embodiments of the present disclosure; for those skilled in the art, various changes, modifications, substitutions, and alterations can be conceived without departing from the principles and spirit of the present disclosure, and the protection scope of the present disclosure is defined by the appended claims and equivalents thereof; and the above behaviors all fall within the protection scope of the present disclosure.

1. A three-electrode sensor integrating positioning and pressure detection, comprising a resistance positioning unit, two spacers, a piezoelectric unit, and an encapsulation layer connected in sequence; wherein the resistance positioning unit is configured to detect a position subjected to force; upper portions of the two spacers are connected to edges of the resistance positioning unit, and lower portions of the two spacers are connected to edges of the piezoelectric unit, with the resistance positioning unit and the piezoelectric unit forming a cavity structure; and the piezoelectric unit is configured to detect a magnitude of force applied, wherein
the resistance positioning unit comprises an insulating layer, a resistance-sensitive layer, and an upper electrode; the resistance-sensitive layer is arranged on a lower surface of the insulating layer, and the upper electrode is arranged on a lower surface of the resistance-sensitive layer; the piezoelectric unit comprises a middle electrode layer, a piezoelectric layer, and a lower electrode layer connected in sequence; when the insulating layer of the sensor is subjected to force and deforms, the resistance-sensitive layer contacts the middle electrode layer, forming a conduction path among the upper electrode, the resistance-sensitive layer, and the middle electrode layer, wherein a resistance value of the resistance-sensitive layer is detected, and position information of a force point is determined; and the upper electrode and the middle electrode layer collect resistance signals, the middle electrode layer and the lower electrode layer collect voltage signals, the middle electrode layer serves as a common working electrode for the resistance positioning unit and the piezoelectric unit, and the upper electrode and the lower electrode layer are respectively connected independently to the resistance positioning unit and the piezoelectric unit, realizing separate detection of spatial position and pressure information of external stimuli.

2. A manufacturing method for a three-electrode sensor integrating positioning and pressure detection, the method being used for manufacturing the three-electrode sensor integrating positioning and pressure detection according to claim 1, comprising the steps of:
S1. cleaning a film and cutting the film to obtain the insulating layer and the encapsulation layer;
S2. cleaning surface stains of the insulating layer and the encapsulation layer;
S3. coating an electrically conductive mixed sensitive material on the lower surface of the insulating layer to form the resistance-sensitive layer, drying the resistance-sensitive layer, and attaching the upper electrode on the resistance-sensitive layer to obtain the resistance positioning unit;
S4. preparing a piezoelectric material solution, polarizing the piezoelectric material solution to obtain a polarized solution, pouring the polarized solution into a mold, followed by drying and demolding to obtain the piezoelectric layer;
S5. attaching a layer of metal electrode on each of two surfaces of the piezoelectric layer to obtain the piezoelectric unit; and
S6. assembling components in an order from top to bottom according to the resistance positioning unit, the two spacers, the piezoelectric unit, and the encapsulation layer, wherein during assembly, the two spacers are used for fixing the resistance positioning unit and the piezoelectric unit, with the resistance positioning unit and the piezoelectric unit not contacting each other when not operating, and non-contact portions form the cavity.

3. The manufacturing method for a three-electrode sensor integrating positioning and pressure detection according to claim 2, wherein the film adopts an insulating film with a thickness of 0.2 mm, and the insulating layer and the encapsulation layer both have dimensions of 64 mm×9 mm.

4. The manufacturing method for a three-electrode sensor integrating positioning and pressure detection according to claim 2, wherein a method adopted during polarization of the piezoelectric material solution is one or a combination of a thermal polarization method, an electric field polarization method, a mechanical stress polarization method, a piezoelectric thin film material polarization method, and a photo-polarization method.

5. The manufacturing method for a three-electrode sensor integrating positioning and pressure detection according to claim 2, wherein a coated electrically conductive mixed sensitive material has a thickness of 0.2 mm-1 mm, and an electrical conductivity range of 0.8×10² S/m-3.0×10² S/m.

6. The manufacturing method for a three-electrode sensor integrating positioning and pressure detection according to claim 5, wherein the piezoelectric layer has a thickness of 0.5 mm-2 mm, and thickness of each spacer and thickness of a demolded piezoelectric material have a ratio of 0.5-2.

7. The manufacturing method for a three-electrode sensor integrating positioning and pressure detection according to claim 5, wherein the drying in S3 is performed at an adopted temperature of 50° C.-60° C., and magnetic stirring during polarizing the piezoelectric material solution is performed at a temperature of 70° C.

8. The manufacturing method for a three-electrode sensor integrating positioning and pressure detection according to claim 5, wherein the electrically conductive mixed sensitive material is formed by mixing an electrically conductive material and a thickening agent, the piezoelectric material solution is formed by mixing a polymer piezoelectric material and a solvent, and the polymer piezoelectric material has a volume fraction of 6%-8% in the piezoelectric material solution.

9. The manufacturing method for a three-electrode sensor integrating positioning and pressure detection according to claim 8, wherein the film is selected from one of polyimide, epoxy resin, polytetrafluoroethylene, polyvinyl chloride, polyethylene terephthalate, and silica; each spacer is selected from one of chloroprene rubber, nitrile rubber, silica gel, plastic, polytetrafluoroethylene and polyethylene; the electrically conductive material is selected from one or a combination of carbon nanotubes, metal nanowires, MXene, and graphene; the thickening agent is selected from one or a combination of methyl cellulose (MC), hydroxyethyl cellulose, sodium alginate, and sodium polyacrylate; the polymer piezoelectric material is selected from one or a combination of polyvinylidene fluoride (PVDF), polyvinyl fluoride, and polylactic acid; the solvent is selected from one or a combination of N,N-dimethylformamide, acetone, N,N-dimethylacetamide, and cyclohexanone.
